(19) United States
(12) Patent Application Publication
(10) Pub. No.: US 2003/0108242 A1
(43) Pub. Date: Jun. 12, 2003

(54) Method and apparatus for processing data

(76) Inventor: Stephen W. Conant, Santa Monica, CA (US)

Correspondence Address: THE HECKER LAW GROUP, 1925 CENTURY PARK EAST, SUITE 2300, LOS ANGELES, CA, 90067, US

(21) Appl. No.: 10/015,931

(22) Filed: Dec. 8, 2001

(51) Int. Cl. G06K 9/46

(52) U.S. Cl. 382/190

(57) ABSTRACT

The invention discloses a method for detecting points of interest in image samples that have a high probability of being present with a consistent spatial relationship to one another, and with high visual similarity, in different images. Some embodiments of the invention exhaustively sample the images, and generate a set of basis functions to capture image components. Each sample is encoded through a set of coefficients produced using the basis functions. Encoding coefficients are then used in a numerical analysis to determine their relative likelihood of representing image locations similar to image locations in other images that containing a common object, symbol or character with a similar viewpoint and scale. The invention proposes a method for identifying identical objects, such as image objects, symbols and characters with differences of object rotation and scaling, differences in lighting and possible foreground occlusion.

### FIELD OF THE INVENTION

This invention relates to the field of image data processing and feature extraction and recognition.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

There is an increasing interest in techniques for processing image data to extract features, identify and match image objects. Image processing techniques may be utilized in automatic feature recognition devices (e.g., Human face recognition), as well as in character reading (e.g. Mail sorting dependent on Zone Identification Postal Code). Face recognition, for example, typically requires recognizing unique examples of a common object, the human face. Such image processing techniques would be a valuable feature for classifying and retrieving image data in databases. Indeed, many available relational databases are capable of storing image data along side with text data. However, while those databases offer a variety of methods for performing searches on text data, they offer only a limited functionality for performing searches on image data. Classifying and characterizing images stored in databases still involves heavy involvement of humans. In fact, visual inspection by the humans eye remains the most accurate approach to feature recognition. This approach is, however, very expensive given the amount of data to be analyzed in most cases.

Existing applications rely on different approaches to analyze images, depending on the type of problem to be solved. Face recognition, for example, typically requires recognizing unique examples of a common object, the human face. Since all faces have a great deal of communality in their features, an approach often used is to produce a relatively small number of informative exemplars, or “principal components”, with which any human face may be described concisely as a linear combination of a few face-like components.

Stereo vision, on the other hand, involves the analysis of different images produced from different angles of the same scene. A primary task in this field is to match points between different images. This is usually termed the “correspondence problem”. In this case, if two points in different images of an identical scene “correspond”, then they indicate a common point in three dimension (3D) space, depicted from slightly different points of view. This allows for the computation of depth within the imaged scene, of a particular location.

A variant of the correspondence problem can also be applied to object recognition. In this problem domain, corresponding point locations are sometimes termed “interest points”. In a general sense, interest points may simply be described as locations in an image that exhibit a measurable property within a range of values that allows them to be distinguished from the vast majority of other points in an image.

The use of these points is based on the assumption that interest points with a measurable property of a certain distinctive value will tend to exist at identical locations on an identical object, symbol, or character depicted in images that may be different from one another, but which contain an identical object, symbol, or character, with a similar scale and from a similar point of view.

A relevant aspect of previous work in object recognition using interest points is that they might be considered to involve two distinct processes:

1) Evaluating a measurable property of an image location for it's suitability as an interest point;

2) Evaluating a property (perhaps distinct from the previous property) of the same image location to determine the degree of it's similarity to a different candidate interest point in another image.

An implicit assumption of these methods is that if the visual appearance of two image portions are different, then this implies that these image portions cannot be from an identical object location. In the real world, however, identical point locations on an object frequently do appear visually different from one image to another, due to slight changes in orientation, size, lighting and occlusion. An inherent limitation on these interest point detectors' ability to facilitate true object recognition is thus introduced.

### SUMMARY OF THE INVENTION

Embodiments of the invention comprise a method for determining locations of interest in image data by utilizing a mechanism for computing and comparing the characteristics of an encoding of an image location. Systems embodying one or more aspects of the invention construct interest point detectors. An interest point detector is a mechanism for identifying regions (or locations) of interest in an image of an object, symbol or character. Using interest point detectors, embodiments of the invention identify portions of an object's image from different images that are likely to represent an identical object's feature.

To construct an interest point detector, the system divides one or more images into samples, and either computes or obtains a number of encoding functions that can be used in representing the image samples. Each sample is then processed to extract a set of encoding factors that represent the degree or proportion that each one of the previously computed encoding functions contribute to a recreation of the image sample in a reversed process. For example, the encodings may comprise weighting coefficients to be used in a linear combination of a set of basis functions, or the encodings may also comprise correlations of banks of gaussian derivatives with the image sample.

Samples and their encoding may then be grouped together into larger image portions, called targets. Embodiments of the invention process the concatenated encoding factors of each target to determine a numerical descriptor value associated with the distribution of the concatenated encoding factors. This value allows for the selection of specific image targets that possess a value within a specified value range.

Embodiments of the invention, pair each target from one image with each target from another image into target pairs. A similarity measure (possibly using a measure different from that used previously to establish a value for the concatenated coefficient distributions) between each member of each target pair is then made. The similarity measure is used, in an embodiment of the invention, to build an association graph. By determining a maximal clique of highly similarity valued target pairs in the association graph, embodiments of the invention provide a mechanism for determining the location(s) of a set of image portions likely to depict an object within an image

For instance, embodiments of the invention can identify distinct locations, common to a particular object, symbol, or character, photographed at similar, but inexact distances and orientations. Thus, the invention resolves problems related to locating similar objects in different images regardless of small differences due to object rotation, scaling, differences in lighting, and possible occlusion. The invention surmounts these difficulties by using a low-level encoding of images, and statistically processing the encoding information to extract similar features in different images.

Embodiments of the invention therefore can identify generic feature locations on an object, symbol, or character that are common to different images of an identical object, symbol, or character, with possible occlusion and a somewhat different scale and point of view. This is useful for purposes of determining whether a particular object is in an image or set of images.

### BRIEF DESCRIPTION OF THE DRAWINGS

FIG. 1 is a block diagram illustrating an overview of the approach for processing image data in accordance with an embodiment of the invention.

FIG. 2 is a flowchart illustrating steps involved in processing image data in accordance with an embodiment of the invention.

FIG. 3 is a flowchart illustrating steps involved in the building of image filters in accordance with an embodiment of the invention.

FIG. 4 is a flowchart illustrating steps involved in processing image data to find locations of interest and possible points of similarity in accordance with an embodiment of the invention.

FIG. 5 is a block diagram exemplifying the process for measuring similarity between image targets and creating an association graph, in accordance with an embodiment of the invention.

FIG. 6 is a flowchart illustrating steps involved in finding image portions of interest and image portions with a high probability of similarity, in accordance with an embodiment of the invention.

### DETAILED DESCRIPTION

An invention for processing image data to detect similar objects within an image or set of images is described herein. In the following description, numerous specific details are set forth in order to provide a more thorough description of the invention. It will be apparent, however, to one skilled in the art, that the invention may be practiced without these specific details. In other instances, well-known features have not been described in detail so as not to obscure the invention.

In the present disclosure, image data are considered in an embodiment of the invention. However, the invention may be implemented in systems that process data other than image data. For example, electrophysiological recordings may be processed, using embodiments of the invention, to locate points of interests, and similarity in points of interest in one or more data recordings. Other data types comprise any type recorded data such electrical waves signal, sounds etc. A location, as defined in the invention may refer to a spatial location, as in the case of images. A location, may also refer to a position in any set of coordinates describing the dimensions associated with one or more representations of the data.

Embodiments of the invention provide a mechanism for processing image data to locate objects within the image that have a high probability of representing identical objects from another image. This is accomplished in accordance with one embodiment of the invention by providing a method for identifying locations of interest within images, assuming that a common object, symbol, or character occurs within both images. Because the method allows for detecting areas of interest which possess a specific spatial relationship to one another, and where similar areas may exist in different images, with similar spatial relationships to one another, the general term used to describe the method for image data processing is an “interest point detector”.

The invention may be embodied as a software program running on any computing device. For example, computing devices for running an application program that implement the invention, may comprise any machine capable of executing binary or byte code. Such devices are typically equipped with one or more central processing units (CPU; e.g., Intel Pentium family CPUs), memory for storing data (e.g., DRAM, SDRAM, RDRAM, DDR), input/output electronic element for exchanging data peripheral elements (e.g., Hard drives, Displays, printers, network cards). Implementations of the invention may also be embodied as electronic integrated circuit devices. Such devices may embody the invention as hard-wired electronic circuits comprising one or more units running some or all of the computation in parallel or in sequence. These computing devices may also comprise one or more electronic circuit elements running software routines for processing data. Other embodiments of the invention may comprise a hybrid system comprising software programs and hard-wired electronic circuits.

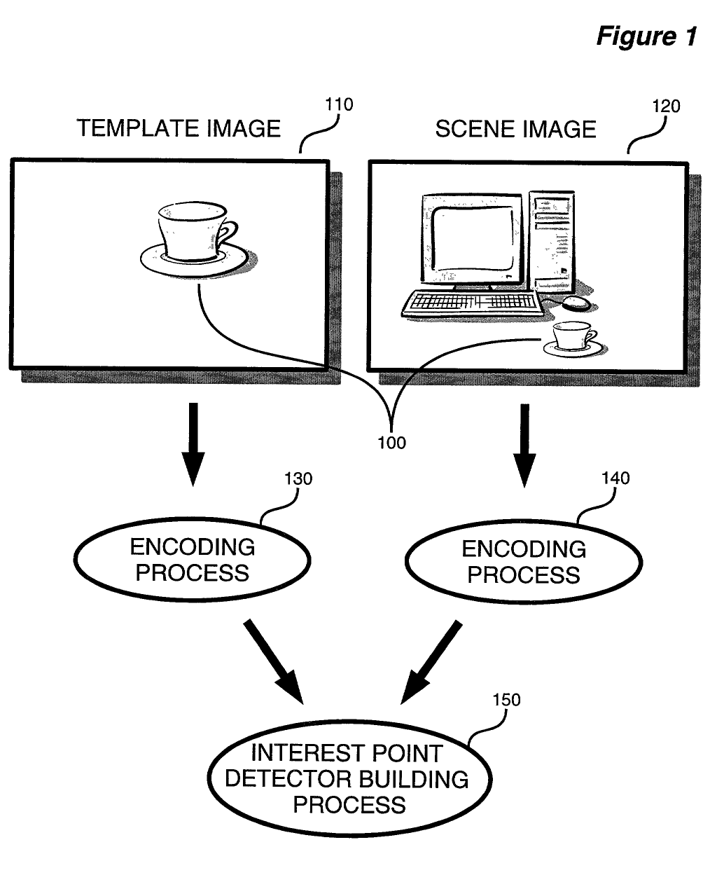

FIG. 1 is a block diagram illustrating an overview of the approach for processing image data in accordance with an embodiment of the invention. In this illustration, two images, 110 and 120, represent a template image and a scene image. In the following, a template image refers to an image used to represent an object. The scene image refers to an image that may or may not contain the object (e.g., 100) depicted in the template image. The scene image may also contain the object, however, from a slightly different view point and/or scale and/or lit from a different direction and/or level. Embodiments of the invention allow the system to construct an interest point detector capable of identifying locations of interest in the template image or the scene image. The approach followed in the invention uses an encoding mechanism for processing (e.g., 130 and 140) each image. The method may involve applying several image manipulation techniques, for example filtering and/or sampling. Embodiments of the invention involve applying one or more statistical and image analysis techniques to image data which provide several numerical descriptors. Numerical descriptors, individually or in combination are intended to be highly relevant in determining if an image location is a useful interest point.

In the embodiment of the invention depicted in FIG. 1, an encoding process 150 uses the results obtained from the encoding process to produce a one or more values. As mentioned earlier, this value allows for the selection of specific image targets that possess a value within a specified value range, and thereby construct an interest point detector. Embodiments of the invention use one or more analysis methods, including statistical methods, to process the encoding results. For example, an embodiment might analyze the distribution of function factors in the encoding to produce a value representative of that distribution, which would be useful in the context of using a range of values to identify interest points.

As another example of a possible measurement process, statistical descriptors, obtained by analyzing the encodings of the image data, may be used to search for correlation's or other measures indicating that the specific encodings possess a high probability for encoding similar image objects. Within the same image or from one image to another, the locations of a particular set of encodings that show a high correlation might indicate the locations that are likely to represent similar image object features.

In a simple task of counting different objects that exist in a given image, the invention may be used to construct an interest point detector that is capable of enumerating, within a given image, regions that have a high probability of representing similar objects. Likewise, in a set of different images, one of the embodiments of the invention provide a tool for detecting locations within different images that represent similar objects.

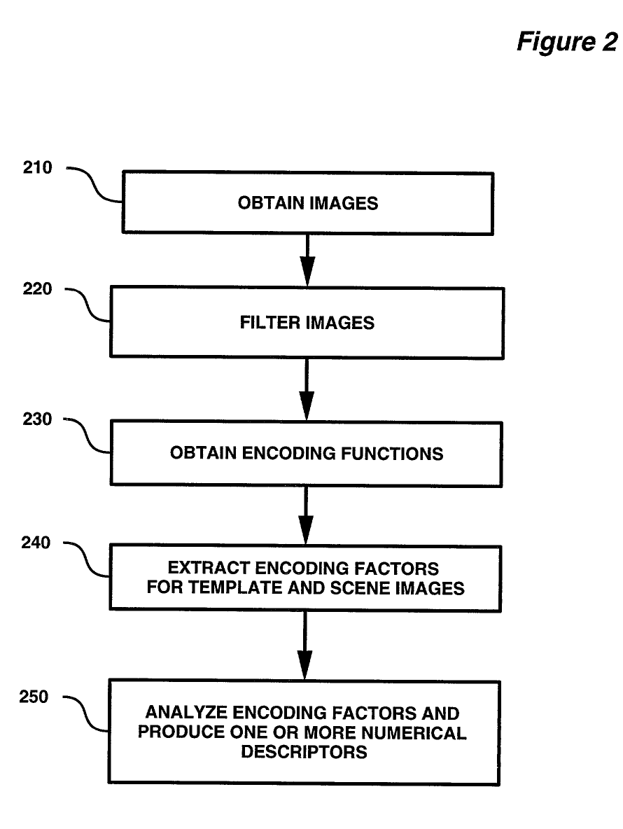

FIG. 2 is a flowchart that illustrates steps involved in processing image data in accordance with one or more embodiments of the invention. At step 210 one or more images are obtained using one or more means for obtaining photographic or constructed images. For example, images may be obtained using film-based photo and movie cameras. The photos are processed, then digitized using an image scanner. Photos may be obtained also using digital photo or movie cameras. The digital images are downloadable into a computer memory, and may be stored on any available digital storage medium. Images may also originate from computer software such as computer aided design software, and from scanning devices such as computerized axial tomography (CAT) scans.

In an embodiment of the invention, for the purpose of testing the method, sets of training and test black and white images were produced from prints of 35 mm. Kodak T400CN Black & White film. The prints were scanned with a Hewlett Packard ScanJet 4100C at 150 dpi, with the option “Sharpen Detail in Photos” set to “On”, converted to a 500×500 pixel, 8 bit black & white grayscale format and saved as text files. Further image processing was done with Matlab and Visual C++.

At step 220, one or more embodiments of the invention apply one or more filters to the images. Filtering images involves convolving image data with a filter. In this context, a filter refers to a numerical method applied to the data, and is different from optical filters which are usually comprised of optical lenses. Numerical filters are able in many instances to reproduce the effects obtained through optical filters. In other instances numerical filters are capable of producing results that cannot be achieved using such optical filters. The reader should note that step 220 is optional and not required in order to implement embodiments of the invention. The invention contemplates the use of any mechanism for making a decision as to whether to filter images and produce the proper filter.

Embodiments of the invention may use filters that are specifically designed to suit a specific requirement. For example, it is known that the large differences between the variance of the low spatial frequencies and the variance of the high spatial frequencies of natural images may create problems for a gradient descent based method searching for structure in the input space. In that case, a filter may be designed to reduce the low frequencies such that convolving the filter with original images results in a whitened version of the images. The whitening of the images results in a relatively flat amplitude spectrum over all spatial frequencies.

In subsequent steps, an original image will refer to the image used in the processing steps. The image may be either the original image in the case filtering is not required, or an image resulting from the filtering process.

At step 230, embodiments of the invention encode images using encoding functions. Encoding functions comprise any processes that are capable representing one or more aspects of an image. Suitable encoding functions can include those that, when combined the encodings they produce, allow for reconstruction of an image as identical as possible to the original image.

Embodiments of the invention use an encoding method inspired by Olshausen and Field, (Olshausen and Field. 1996, Nature, vol. 381, 607-609). The encoding method is based on the assumption that a given image I_{(x,y)} is composed of a set of encoding functions called “basis functions” φᵢ:

I_{(x,y)}=Σaᵢφ_{i(x,y)}

aᵢ describes a set of coefficients related to the basis functions. Olshausen and Field also propose a method for computing a set of basis functions and encoding coefficients. The method conducts a search for basis functions, such that a linear combination of the basis functions results in an image that is as close as possible to the original image (I_{(x,y)}), and that the distribution of the encoding coefficients is characterized by a small number of coefficients that have a large absolute value (ie. a sparse distribution). The set of computed basis functions is intended to reproduce the original image with minimal error using a small number of heavily weighted basis functions in linear combination. There is no specific rule as to how many basis functions are suitable for representing images. Embodiments of the invention use a fixed number of basis functions. The number can be set based on one or more parameters. The computing of basis functions may include a decision step that involves computing a number of basis functions to be determined for a specific image or samples there of.

An embodiment of the invention contemplates using a threshold of convergence to terminate the process of the computing of basis functions.

An embodiment of the invention uses a fixed number of one hundred and forty four (144) basis functions, each of size 12×12 pixels. This is considered in this case to be an overcomplete set of basis functions, since it can be observed that 144 exceeds the effective dimensionality of the input space (for example, the number of non-zero eigenvalues in the input covariance matrix). While embodiments of the invention utilize an overcomplete set of basis functions, overcompleteness may in fact not be a necessary requirement for the invention.

Embodiments of the invention may also use a set of encoding functions constructed by means other than those described above.

At step 240, embodiments of the invention further process the image data using the encoding functions to compute encoding factors. Encoding factors are factors that are associated with the encoding functions. They may in fact represent the degree or proportion that each one of the previously computed encoding functions contribute to a recreation of the image sample. They may also represent the degree of correlation between the image and the encoding functions. In general then, the encoding factors express a relationship between the encoded image and the encoding functions. For example, an embodiment of the invention processes image data using the basis functions computed at step 230 to extract related encoding coefficients. The preferred embodiment of the invention uses optimization methods to select encoding coefficients that are as sparse as possible.

In an embodiment of the invention, the image encoding was accomplished by modifying the method of Olshausen and Field (mentioned above). The modification comprises keeping a set of previously derived basis functions constant, while searching for sparse encoding for images that used the supplied basis functions to reproduce the original image as accurately as possible.

Embodiments of the invention may use any data manipulation techniques capable of producing sparse encodings of encoding coefficients.

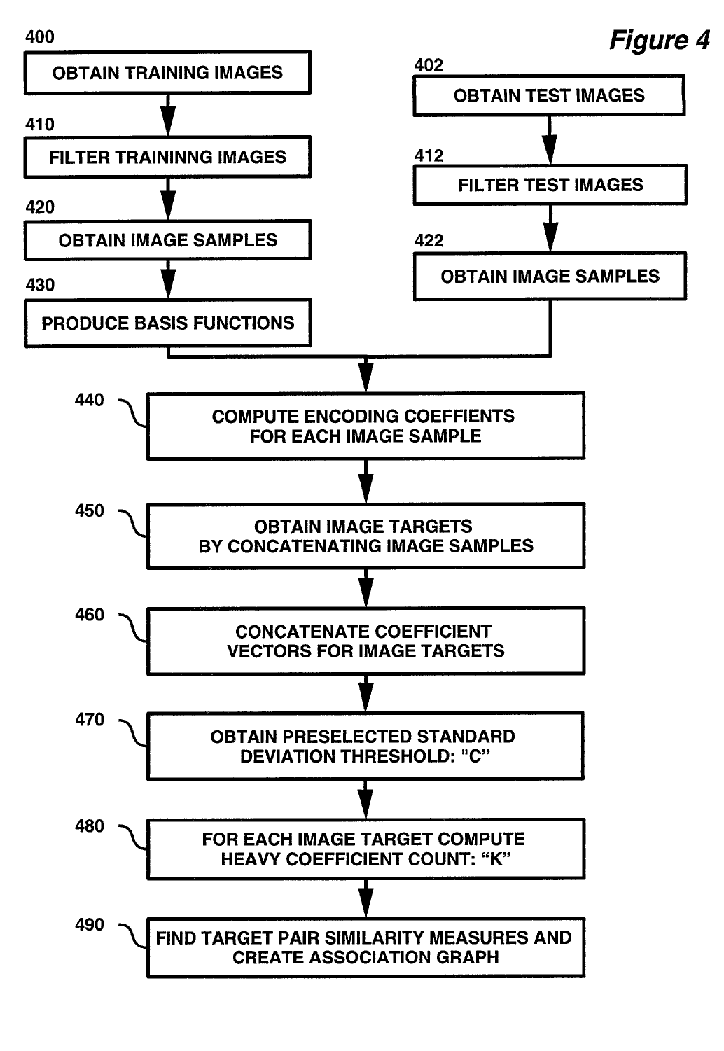

At step 250, embodiments of the invention process the encoding factors, previously computed, through one or more analytical methods (e.g., through statistical analysis). The result of such analysis is one or more numerical descriptors. Embodiments of the invention use one or more analysis methods that allow for extracting one or more numerical descriptors. In an embodiment of the invention a numerical descriptor is a specific measure of a specifically defined long tailed distribution for an image portion. In embodiments of the invention (as described in FIG. 4) a method for analyzing the encoding factors involves building a threshold value for encoding factors. A numerical descriptor is then built by counting the number of encoding factors that are greater than the threshold.

Numerical descriptors from all image samples are then analytically processed to determine those samples that are likely to contain significant encoding information. For example, an embodiment of the invention uses a method for determining a range of values (see below in FIG. 4). Image samples that have numerical descriptors whose value is within the set range are selected as points of interest.

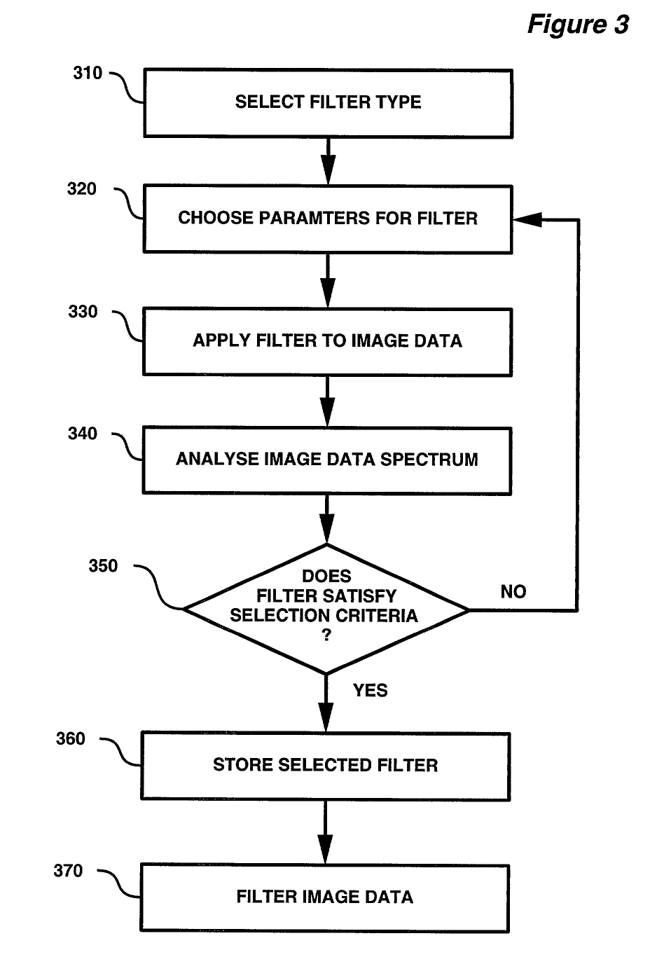

FIG. 3 is a flowchart diagram illustrating steps involved in the building of image filters in accordance with an embodiment of the invention. At step 310, an embodiment of the invention selects a filter type. Several numerical filters for filtering image data are available. Embodiments of the invention may select one or more filters to apply to image data. At step 320, embodiments of the invention select parameters for the selected filter or filters. The parameters of the filter are numbers that characterize the filter. For example, a Gaussian filter is characterized by its standard deviation. A Gaussian filter is a filter that uses a Gaussian shaped (or bell-shaped) distribution. An embodiment of the invention uses a filter composed of the sum of one positive and one negative Gaussian distributions. In this case, in accordance with an embodiment of the invention, one may choose a standard deviation for each of the distributions. The resulting filter is a sombrero hat shaped distribution.

At step 330, the filter is convolved with the image data. At step 340, image data is analyzed for checking the filter's performance. In an embodiment of the invention, image data is spectrally analyzed using the Fast Fourier Transform. Other embodiments may select a different type of analyses. The choice of filter performance may be based on one or more criteria. In an embodiment of the invention, the criteria may depend on the type of numerical methods used in subsequent steps to manipulate the image data. For example, when gradient descent search methods are used in subsequent data processing steps, adequate filters may be those that reduce the standard deviation of the amplitude of the image signal in the range of low frequencies in the spatial frequency domain.

An embodiment of the invention, checks at step 350 the filter's performance according to a pre-selected criterion. Other embodiments may compute one or more criteria based on input data. To this end, the invention contemplates method steps for processing image data in order to produce criteria for selecting filters. If the filter does not produce satisfactory results, then the filters parameters are modified according to step 320, and applied again. If the filter's performance is satisfactory, an embodiment of the invention may store the filter's parameters at step 360. At step 370, the image data is convolved with the selected filter to produce images that are used for processing in subsequent steps.

In an embodiment of the invention, acceptable filter performance is considered to be that which results in a relatively flat amplitude spectrum over all spatial frequencies in the filtered image.

FIG. 4 is a flowchart illustrating steps involved in processing image data to find locations of interest in accordance with an embodiment of the invention. In the following example, basis functions (as described above) are used as encoding functions, and encoding coefficients are used as encoding factors associated with the basis functions. In the example of FIG. 4, two sets of images are obtained, the training images and the test images.

The training images, are the images used to construct the basis functions. Some, all, or none of the training images maybe also be included in the set later described as test images. In one embodiment of the invention, all of the training images were different from the test images. Specifically, in an embodiment of the invention, all of the training images were images of nature scenes (rocks, trees, shrubs, etc.), which had no man made objects (or straight lines) appearing in them. Other embodiments of the invention may use a training set that comprise other types of images (e.g., un-natural images having straight lines).

Test images refer to the images (both template images and scene images described above) that are the subject material of embodiments of the invention from which the interest points are detected, typically for recognition purposes.

At step 400, training images are obtained using any one of the means described above. A training image may also be generated through software and/or a scanning device. For example, an image of a body organ may be generated by a medical imagery device.

At step 402, a set of test images is obtained. In an embodiment of the invention, template test images may be photographs of objects placed against a neutral background and/or isolated from the rest of the background and foreground by selective focus. Further, in an embodiment of the invention, scene test images may be photographs of objects in a cluttered background. The method for obtaining test images is similar to the one used for the training images (ie. an image of a body organ may be generated by a medical imagery device as described above). In an embodiment of the invention, at steps 410 and 412, the training and test images are filtered through a filter. The particular filter used in one embodiment of the invention was a difference of Gaussian filter. The filter is comprised of a sum of one positive and one negative Gaussian distributions having different standard deviations. The parameters of the filter may be different for a given imaging system, and can be optimized (see above). The filter, in accordance to one embodiment of the invention, was a 13×13-pixel filter using a positive two-dimensional Gaussian distribution, and a negative two-dimensional Gaussian distribution. Both the positive and negative Gaussian distributions are centered about the center pixel of the filter.

Training and test images are filtered at steps 410 and 412, respectively. Embodiments of the invention may use the procedure described in FIG. 3 to build different specific filters for training images and test images. However, an embodiment of the invention may select a filter and apply it to both training images and test images.

Embodiments of the invention obtain image samples from both training images, at step 420, and from training images, at step 422. Each image sample comprises a small area of the initial image. In an embodiment of the invention, image samples are collected by scanning the image using a window having a size smaller than the original image. The scanning window is moved by steps throughout the image. At each step a sample is collected. The step size may be pre-selected according to a predetermined value, or the step size may be automatically computed according to one or more criteria. The invention contemplates a method for automatically computing the step size. For example, if it is determined, through pre-processing of the image data, that the image contains spatially condensed features, the step size may be set to be very small (e.g. 1 pixel). If the pre-processing of the image indicates that the image features are not condensed (e.g., high image resolution) the step size may be increased. The preferred approach chooses is the one that minimizes the amount of computation without reducing the quality of the sampling results. The invention also contemplates using a method for automatically determining a window size for sampling an image or a set of images. In an embodiment of the invention, the window size was set to 12×12 pixels.

At step 430, the training images are used to produce the basis functions in an embodiment of the invention. In an embodiment of the invention, one or more image samples originating from the training image are used to compute basis functions. However, in other embodiments of the invention, one or more samples may be selected from both training and test images or from either training or test images.

At step 440, the encoding coefficients are extracted using the basis functions previously computed. In an embodiment of the invention, the coefficients are computed (as described above) following a process similar to the one for determining the set of basis functions. In an embodiment of the invention, computing the coefficients uses a gradient descent search method to find coefficients that are as sparsely distributed as possible. In a gradient descent search method, local gradients are computed for each variable searched around its value. The value of the variable is changed incrementally towards the minimum values of the gradient. Other embodiments of the invention may use any suitable computation technique to find encoding coefficients. The invention contemplates implementing several different computation methods, and a process for selecting, among different computation methods, a suitable method on a case-by-case basis. The encoding coefficients for each image sample are stored in a vector that is used in later analyses to characterize the image sample for which the coefficients were computed. The encoding thus produced consist of vectors of coefficients, each coefficient specifying the weighting of each component of the set of independent components, that in linear combination reproduce the original image sample, as closely as possible within the overall system's capabilities.

In other embodiments of the invention, the encoding may consist of vectors of values that have different relationships with their respective components, other than that described in the embodiment of the invention herein (ie. representing the weighting of their respective component in a linear combination that attempts to reproduce the original image sample). For example, in an embodiment of the invention, the encoding vectors may consist of correlation values of the image sample with a bank of gaussian derivatives, or the results of filtering an image with a set of log-Gabor filters.

In the various embodiments of the invention contemplated above, the creation of components as well as the respective encoding process would differ accordingly from that presented in the embodiment of the invention described in this patent application.

In an embodiment of the invention, two or more image samples are grouped into a larger image area at step 450. For example, 12×12 pixel samples may be used as quadrants in larger image areas of size 24×24 pixels. The concatenation process reflects the grouping of image samples previously generated into composite samples to which it is referred as image targets (or if the context is clear, simply “targets”). The vectors related to two or more image samples are concatenated, at step 460. The concatenation of the vectors of coefficients of the 4 quadrants of each “sample” produces a vector of 576 coefficients, constituting an image target vector.

At step 470, an embodiment of the invention obtains a preselected standard deviation threshold. The standard deviation threshold is referred to hereinafter as “C”. A standard deviation of the encoding coefficients stored in each concatenated vector is computed for each image target. In an embodiment of the invention, “C” is a set limit used in later steps of the invention to determine which encoding coefficients are to be considered. In an embodiment of the invention, “C” is determined empirically based on statistical observations. The invention contemplates using an estimation or an empirical method for computing a preselected standard deviation threshold. In an embodiment of the invention, “C” is set to two point seven (2.7) which was determined empirically. The optimal value may vary due the particular implementation of the imaging system, as well as the particular encoding method used.

After a preselected standard deviation threshold has been determined, at step 480, a count of heavy coefficients is calculated for each target vector. Heavy coefficients are those whose absolute value exceed a value of “C” times the standard deviation of the sample vector. The heavy coefficient count is referred to hereinafter as “K”. In the context of this example, “K” is a numerical descriptor (see above) that measures, from a statistical distribution point of view, the tails of the distribution of the target's coefficients.

After selecting a specific C value, and the K values for each target are calculated, a range of K values is selected. In an embodiment of the invention, the Chebyshev Inequality insures that the proportion of standardized values in a distribution that are larger than a given constant k in absolute value cannot exceed 1/k². Hence if we use C (k above)=2.7 then 1/k²=1/(2.7)², approximately 0.1372. Given that 576*0.1372=79.0123, therefore the highest K value possible in an implementation with vectors of size 576 is 79. In an embodiment of the invention, a range of K from 80 to some lower bound is selected. The invention contemplates using an optimization method for computing an optimal lower bound of the K range. An interest point detector therefore selects only those image targets with a K value between an absolute theoretic upper bound and a lower bound. Embodiments of the invention, then use K as a key for sorting all image target vectors (e.g., in descending order).

At step 490, an embodiment of the invention computes measures of the similarity between image targets. In an embodiment of the invention a target pair is comprised of a single image target from a template image and single image target from a scene image. Each target pair has a similarity value associated with it that is a measure of the similarity between the template image target and the scene image target. The process of finding points of interest, and computing the similarity of target pairs is explained in further detail below.

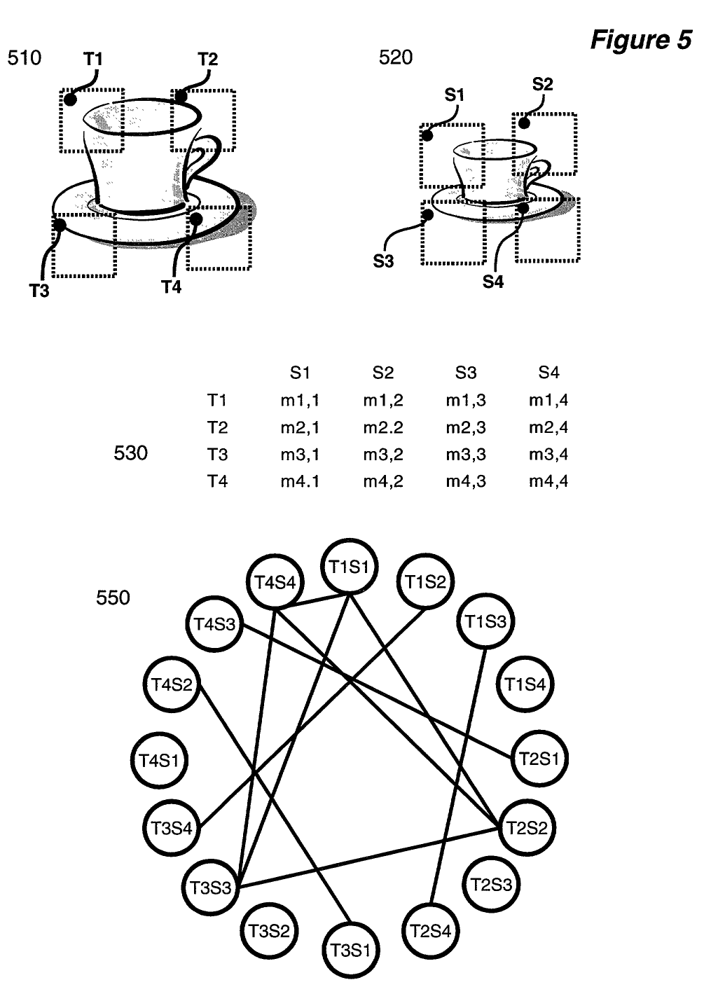

FIG. 5 is a block diagram exemplifying the process of measuring similarity between image targets, in an embodiment of the invention. In this example, blocks 510 and 520 depict two images, a template image, and a scene image. The template image depicts an object, isolated from a blank background by selective focus. The scene image may or may not contain the object in the template. The selection of image targets uses a specified range of K values. The image targets within the template and the scene having K values within the specified range are selected. This example considers four (4) image targets (T1, T2, T3 and T4) associated with the template image and four (4) image targets (S1, S2, S3 and S4) associated with the scene image. The pixel in the upper left-hand corner of each target is the indexing pixel for that target, and serves only as a pair of identifier coordinates for that target. A similarity measure is computed for each target in the template to each target in the scene image to produce [(Number of Template Targets)×(Number of Scene Targets)] target pairs. For example, the similarity measure of target pair T3S2 is m3,2. Block 530 shows a table representing similarity measures between targets from the template image and targets from the scene image.

Embodiments of the invention create an association graph of target pairs, and then find the highest valued maximal clique within the association graph. In one embodiment of the invention, if the scene target is the most similar to a given template target, and that template target is the most similar to that scene target, then a target pair comprised of that template target and that scene target is created in the association graph. In another embodiment of the invention, every target in the template image is paired with every target in the scene image. However, the invention contemplates using preprocessing techniques for determining image targets unlikely to produce a high similarity measure, or that would be unlikely members of a high valued maximal clique in the association graph. Eliminating unimportant image targets reduces the amount of computation required.

Embodiments of the invention compute a cross product of the similarities for each template target with each scene target. An embodiment of the invention uses a similarity measure that is equal to 0.5-0.5(corr_{abs}), where corr_{abs} is the correlation of the absolute gradient magnitude of one target to another. Hence it is an error measure, with a range of 0.0 (perfect positive correlation) to 1.0 (perfect negative correlation).

Block 550 is a graphical representation of the association graph of target pairs. In this example, the association graph represented in block 550 has 16 target pairs from 4 Template targets and 4 Scene targets. An edge (line connecting two target pairs) is created between target pairs if the spatial relationship (relative bearing and length ratio) between the two template targets, and between the two scene targets is within set limits. In an embodiment of the invention, the relative bearings are within 0.0625×π radians, and the difference between the distance of the two template targets from one another (TempDist), and the distance of the two scene targets from one another (SceneDist), is less than 20% of the distance between the two template targets (TempDist). For example: abs(TempDist−SceneDist)<(0.2×TempDist)

In an association graph groups of nodes (target pairs in the present invention) form sets (also called cliques) of completely connected nodes. A maximal clique is a clique that is not contained in any other clique. For example, in FIG. 5, the largest maximal clique in the graph is T1S1,T2S2,T3S3,T4S4. Embodiments of the invention find all maximal cliques for the association graph.

In embodiment of the invention, a value of each maximal clique is computed by summing the reciprocal of the similarity value of each target pair in the clique. Since the similarity values range from greater than 0.0 (perfect positive correlation) to less than 1.0 (perfect negative correlation), summing the reciprocals have the attractive property of being able to compare cliques of different size and different average similarity to one another. For example, a clique of size 4 with an average similarity value of 0.5 will have the same overall value as a clique of size 2, with an average similarity value of 0.25 (twice as accurate). Both cliques would have the value 8; i.e. 2+2+2+2, or 4+4.

In embodiments of the invention, the highest valued maximal clique of target pairs in the association graph usually represents the corresponding targets in both the object template and the scene, if the object is present in the scene, with a similar point of view and scale. If the object is un-occluded in the scene this will be almost certainly be the case. If the object is partly occluded, the highest valued maximal clique in the association graph will also frequently indicate the location of parts of the object that are un-occluded. If the object is not present at all, then the highest valued maximal clique is typically of a very small size, with a lower average similarity value, thus distinguishing it from a true object match.

In embodiments of the invention, an additional parameter, called center-point distance can be also computed to check for true matches. This can be accomplished by computing an additional clique (ACCcliq) of a size that is greater than a specific proportion of the size of the highest valued maximal clique (TVcliq), having the highest average similarity value for it's component target pairs By averaging the x and y coordinate differences between the template member and the scene member of each target pair of the ACCcliq, embodiments of the invention can compute a virtual center-point for the object in the scene. The same computation may be applied to the target pairs in the TVcliq. The distance between these two virtual center-points is the center-point distance. A true match must have a center-point distance close to zero. On the other hand, a false match is in no way constrained to have a center-point distance anywhere close to zero.

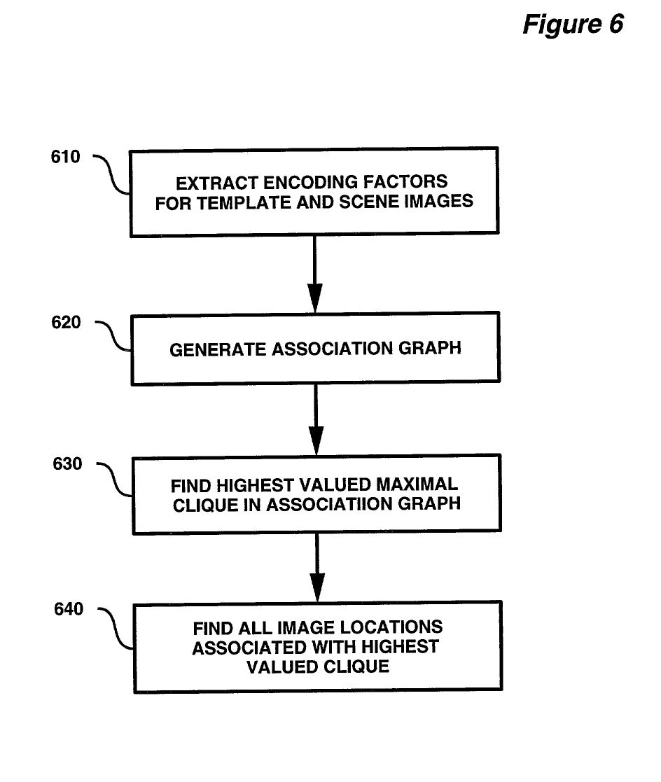

FIG. 6 is a flowchart illustrating steps involved in finding image portions of interest and image portions with high similarity probability, in accordance with an embodiment of the invention. Embodiments of the invention extract encoding factors, at step 610, in accordance with the method steps described in FIGS. 2 and 4. At step 620, embodiments of the invention create image target pairs comprising image targets from a template image and image targets from a scene image, and generate a graph where the nodes are comprised of the target pairs. A similarity measure is computed for each image target pair. At step 630, a search is conducted to find the maximal valued cliques in the association graph. At step 640, a search is conducted to find image locations associated with the highest valued maximal cliques.

The invention can be adapted to resolve a particular problem when comparing images representing objects that are rotated around an axis perpendicular to the image plane. In embodiments of the invention, rotational invariance might be added by insuring that the functionals are circular. Thus a canonical representation might be achieved by a transform that seeks to rotate the functional from its original orientation in an image to a canonical representation. In some embodiments, the canonical representation might be such that the luminance (gray scale value) distribution must have the greatest possible gradient between the top half of the functional and the bottom half of the functional (the darker side being on the bottom). In such a transformation, the angle of rotation to produce the canonical representation would be preserved, thus allowing evaluation by techniques such as traditional association graphs (or some other method) to be completely invariant to rotation around an axis perpendicular to the the image plane.

Likewise, embodiments of the invention implement achieve true view invariance by the use of multiple views (e.g., of order 10 degrees or so difference between each) for an individual template. Thus a completely view invariant system would consist of multiples templates for objects, consisting of multiple views and scales, along with an associated system that could find the view and scale that produced the set of image portions (designated by the above described interest point detector), most likely to represent a particular object.

A true object recognition system, embodying the invention, may rely on a bank of object detectors that would process a given scene in parallel. For example, in a scene image that depicts a medicine cabinet showing four (4) items: a bottle of pain relief pills, a bottle of Vitamin C, a bottle of cold tablets, and a razor, four detectors, representing the four items, respectively, can be used. Plus an extra detectors (e.g., one for a banana) can be used. Each one of the detectors would produce a list of its best estimations of where their respective object is, along with their second best estimation, third best estimation, as illustrated in table-1 below:

TABLES-1
Chart of Detection Scores
(higher is better)

| | | pain | | | |
|---|---|---|---|---|---|
| | Detector | relief | Vitamin | Cold | |
| | Type | pills | C | Tablets | Banana |
| Actual | XXXXXXXXX | XXXXXXX | XXXXXXX | XXXXXXX | XXXXXXX |
| Object and | XXXX | XXXXXX | XXXXXX | XXXXXX | XXXXXX |
| Location | | | | | |
| pain relief | XXXXXXXXX | 95 | 83 | 72 | 21 |
| pills | XXXX | | | | |
| (Location | | | | | |
| 1) | | | | | |
| Vitamin C | XXXXXXXXX | 79 | 81 | 35 | 31 |
| (Location | XXXX | | | | |
| 2) | | | | | |
| Cold | XXXXXXXXX | 73 | 53 | 91 | 17 |
| Tablets | XXXX | | | | |
| (Location | | | | | |
| 3) | | | | | |
| Razor | XXXXXXXXX | 9 | 21 | 2 | 42 |
| (Location | XXXX | | | | |
| 4) | | | | | |

In this example, an embodiment of the invention may use the object detectors to find the location of each of the items in the image. Assuming, the medicine cabinet as having a number of distinct locations (e.g., 1.4), and there is in reality an object in each location, and the detector battery can detect which object is in each location. For each location (1.4), it is possible to look across and find the detector that has the highest output which reveals the answer. In this example, The highest score for the Vitamin C detector is Location 1 (where the pain relief pills bottle is). However, the pain relief pills bottle detector has the highest score for Location 1, so it provides the correct answer. If the Vitamin C detector was the only one used, it would have given us a false positive at Location 1.

Furthermore, the highest score for Location 4 (where the razor is) is the Banana detector. It has a relatively low score however of 42 . . . so a global minimum threshold is set (e.g., to 50), that has to be exceeded for a positive match, the false positive response of the Banana detector can be eliminated.

The present invention is an interest point detector that identifies image samples that have a high probability of being present, with high visual similarity, in different images that are similarly processed, assuming that each image depicts a significant amount of surface area of an identical object, symbol, or character, with a similar viewpoint and scale.

The invention discloses a method for identifying objects that may exhibit some rotation and scale differences from one image to another. Thus a method and apparatus for processing one or more image data to determine image locations having a highest probability of containing similar object representations.

What is claimed is:

1. A method for constructing an interest point detector comprising:
obtaining a set of encoding functions describing a plurality of data samples of a data set;
obtaining a set of encoding factors associated with said set of encoding functions;
obtaining a plurality of numerical descriptors associated with said plurality of data samples by analyzing said set of encoding factors using a threshold criterion; and
obtaining a subset of numerical descriptors from said plurality of numerical descriptors by analyzing said plurality of numerical descriptors.

2. The method of claim 1 wherein said data samples further comprise image data samples.

3. The method of claim 1 wherein said set of encoding functions further comprises a set of basis functions.

4. The method of claim 1 wherein said step of obtaining a set of encoding factors further comprises computing a set of encoding coefficients.

5. The method of claim 1 wherein said step of obtaining a subset of numerical descriptors further comprises obtaining range criteria for selecting said subset of numerical descriptors from said plurality of numerical descriptors.

6. A method for processing image data comprising:
obtaining image data for at least one image;
obtaining a plurality image samples from said image data;
producing a set of encoding functions for said at least one image;
extracting a set of encoding factors associated with said set of encoding functions for each one of said plurality of image samples;
obtaining a plurality of target images by concatenating two sets or more of said set of encoding factors;
obtaining a set of of numerical descriptors using said set of encoding factors for each one of said plurality of target images; and
obtaining an image object detector using said plurality of numerical descriptors from said at least one image.

7. The method in claim 6 wherein said step of obtaining image data for at least one image further comprises obtaining digitized image data.

8. The method in claim 6 wherein said step of obtaining image data for at least one image further comprises convolving said image data with a numerical filter.

9. The method in claim 6 wherein said plurality of image samples further comprises adjacent image areas.

10. The method in claim 6 wherein said plurality of image samples further comprises a plurality of overlapping image areas.

11. The method in claim 6 wherein said plurality of image samples further comprises a plurality of non-overlapping image areas.

12. The method of claim 6 wherein said step of producing a set of encoding functions further comprises producing a set of basis functions.

13. The method of claim 6 wherein said step of producing a set of encoding functions further comprises producing an overcomplete set of encoding functions.

14. The method of claim 6 wherein said plurality of encoding factors further comprises a plurality of encoding coefficients.

15. The method of claim 14 wherein said plurality of encoding coefficients further comprises a plurality of coefficients having a sparse distribution.

16. The method of claim 6 wherein said step of obtaining a plurality of numerical distributions further comprises computing a standard deviation threshold.

17. The method of claim 6 wherein said step of obtaining a plurality of numerical distributions further comprises computing a set of boundaries for selecting from said plurality of numerical descriptors.

18. The method of claim 6 wherein said step of obtaining an image object detector further comprises using an association graph.

19. The method of claim 6 wherein said step of obtaining an image object detector further comprises measuring a similarity value between a plurality of point pairs from said at least one image.

20. The method of claim 6 wherein said step of obtaining an image object detector further comprises locating groups of target image pairs having a highest valued maximal clique.
